(19) United States
(12) Patent Application Publication
(10) Pub. No.: US 2024/0346333 A1
(43) Pub. Date: Oct. 17, 2024

(54) METHOD, DEVICE, AND PRODUCT FOR GENERATING USE CASE INTERFACE IN NEUROMORPHIC COMPUTATION

(71) Applicant: Dell Products L.P., Round Rock, TX (US)

(72) Inventors: Yuhong Nie, Shanghai (CN); Tianxiang Chen, Shanghai (CN); Sanping Li, Beijing (CN)

(21) Appl. No.: 18/144,294

(22) Filed: May 8, 2023

(30) Foreign Application Priority Data
Apr. 14, 2023 (CN) 202310403703

(51) Int. Cl. G06N 3/10

(52) U.S. Cl. CPC G06N 3/105

(57) ABSTRACT

Embodiments of the present disclosure provide a method for generating a use case interface in neuromorphic computation. The method includes: receiving a request for generating a use case interface in the neuromorphic computation, and retrieving, based on key information in the request, a neuromorphic use case and an environment configuration corresponding to the request. The method further includes: setting one or more of a software environment and a hardware environment based on the environment configuration in response to a confirmation on the neuromorphic use case and the environment configuration, generating a software interface and/or a hardware interface, installing the neuromorphic use case based on the software interface and/or the hardware interface, and generating a use case interface in the neuromorphic computation based on the installed neuromorphic use case. With this method, a ready-to-use solution can be provided to users, substantially reducing the complexity otherwise associated with building models and environments.

### RELATED APPLICATION

The present application claims priority to Chinese Patent Application No. 202310403703.8, filed Apr. 14, 2023, and entitled “Method, Device, and Product for Generating Use Case Interface in Neuromorphic Computation,” which is incorporated by reference herein in its entirety.

### FIELD

Embodiments of the present disclosure relate to the field of computers and, more particularly, to a method, an electronic device, and a computer program product for generating a use case interface in neuromorphic computation.

### BACKGROUND

Neuromorphic computation is a type of system engineering that imitates the way the human brain processes information to customize chip structures, which matches hardware with algorithms to achieve faster and more energy-efficient computing. Neuromorphic computation is used in a wide range of fields such as sensing, robotics, medical care, and large artificial intelligence applications.

### SUMMARY

Embodiments of the present disclosure provide a method, an electronic device, and a computer program product for generating a use case interface in neuromorphic computation.

According to a first aspect of the present disclosure, a method for generating a use case interface in neuromorphic computation is provided. The method includes: receiving a request for generating a use case interface in the neuromorphic computation, and retrieving, based on key information in the request, a neuromorphic use case and an environment configuration corresponding to the request. The method further includes: setting one or more of a software environment and a hardware environment based on the environment configuration in response to a confirmation on the use case and the environment configuration, generating a software interface and/or a hardware interface, installing the neuromorphic use case based on the software interface and/or the hardware interface, and generating a use case interface in the neuromorphic computation based on the installed neuromorphic use case.

According to a second aspect of the present disclosure, an electronic device is provided. The electronic device includes at least one processor; and a memory coupled to the at least one processor and having instructions stored therein, wherein the instructions, when executed by the at least one processor, cause the electronic device to perform actions including: receiving a request for generating a use case interface in neuromorphic computation, and retrieving, based on key information in the request, a neuromorphic use case and an environment configuration corresponding to the request. The actions further include: setting one or more of a software environment and a hardware environment based on the environment configuration in response to a confirmation on the use case and the environment configuration, generating a software interface and/or a hardware interface, installing the neuromorphic use case based on the software interface and/or the hardware interface, and generating a use case interface in the neuromorphic computation based on the installed neuromorphic use case.

According to a third aspect of the present disclosure, a computer program product is provided. The computer program product is tangibly stored on a non-transitory computer-readable medium and includes machine-executable instructions, wherein the machine-executable instructions, when executed by a machine, cause the machine to perform steps of the method in the first aspect of the present disclosure.

### BRIEF DESCRIPTION OF THE DRAWINGS

By description of example embodiments of the present disclosure, provided in more detail herein in connection with the accompanying drawings, the above and other objectives, features, and advantages of the present disclosure will become more apparent, wherein in the example embodiments of the present disclosure, the same reference numerals generally represent the same elements. In the accompanying drawings:

FIG. 1 illustrates a schematic diagram of a neuromorphic computation system comprising a use case interface generation system according to embodiments of the present disclosure;

FIG. 2 illustrates a flow chart of a method for generating a use case interface in neuromorphic computation according to embodiments of the present disclosure;

FIG. 3 illustrates a schematic diagram of the overall architecture of a use case interface generation system according to embodiments of the present disclosure;

FIG. 4 illustrates a schematic diagram of the internal architecture of a neuromorphic software-hardware simulation platform in a use case interface generation system according to embodiments of the present disclosure;

FIG. 5 illustrates a schematic diagram for a user to generate a use case interface using a use case interface generation system according to embodiments of the present disclosure; and

FIG. 6 illustrates a block diagram of an example device suitable for implementing embodiments of the present disclosure.

### DETAILED DESCRIPTION

Illustrative embodiments of the present disclosure will be described in more detail below with reference to the accompanying drawings. While some specific embodiments of the present disclosure are shown in the accompanying drawings, it should be understood that the present disclosure may be implemented in various forms, and should not be limited to the embodiments set forth herein. Rather, these embodiments are provided to make the present disclosure more thorough and complete and to fully convey the scope of the present disclosure to those skilled in the art.

The term “include” and variants thereof used in this text indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects, unless otherwise specifically indicated. Similar reference numerals may indicate similar elements.

The idea of neuromorphic computation to imitate the activities of the brain for intelligent, efficient, and low-power computing has attracted a lot of attention. However, it does not seem to have developed well so far. The challenge in using neuromorphic computation for hands-on manipulations or experiments is how to reduce complex operations and make the comparison and selection of solutions easier.

The process of doing neuromorphic computation experiments is often overly complex. Performing neuromorphic computation experiments usually involves environment setting and modeling. However, both of these two steps are particularly difficult for an average user. For the environment setting step, it usually involves building a corresponding software simulator, or even finding hardware that can be accessed and building a relevant software backend to enable the hardware. For the modeling step, it needs to include code inputting, neuron model construction, and general model training, which involves a large number of neuromorphic algorithms. Therefore, how to handle all the above complex operations to implement the whole neuromorphic experiment for a professional problem is one of the challenges for users.

Moreover, it is difficult to build neuromorphic use cases that point to generic professional problems. Unlike conventional deep learning use cases, it is very difficult to build neuromorphic use cases due to the lack of a generic and uniform neuromorphic model. In general, in addition to understanding professional problems, users are required to understand a series of algorithms for time-based encoding methods, neural modeling methods, and training methods that are completely different from conventional deep learning. For users focusing on professional problems, it is very difficult to build neuromorphic use cases without an expert, which leads to reliance on experts and additional communication time costs.

In other respects, it is even more difficult to compare use cases in various environments. In order to obtain the best solution to a professional problem, it is necessary to try and compare use cases and various software/hardware in a simulation platform. However, it is very difficult to build use cases either on a software simulator or on real hardware through a manually implemented software backend, let alone create use cases in various environments. Therefore, it is very useful for users to find a simple way to compare use cases in various environments in order to select the best solution for a professional problem.

At least to address the above and other potential problems, embodiments of the present disclosure provide a method for generating a use case interface in neuromorphic computation. The method includes: receiving a request for generating a use case interface in the neuromorphic computation, and retrieving, based on key information in the request, a neuromorphic use case and an environment configuration corresponding to the request from a neuromorphic use case repository. The method further includes: setting one or more of a software environment and a hardware environment based on the environment configuration in response to a confirmation on the neuromorphic use case and the environment configuration; generating a software interface associated with the software environment and/or a hardware interface associated with the hardware environment; installing the neuromorphic use case based on the software interface and/or the hardware interface; and generating a use case interface in the neuromorphic computation based on the installed neuromorphic use case. With this method, a ready-to-use solution for neuromorphic use cases can be provided to users. This solution is responsible for the process of building neuromorphic models and environments, and in this way, users are freed from these manual and complex operations and can focus on their professional problems. Moreover, by providing flexible options for experimentation in different software/hardware environments, this solution can help users to easily make the best choices for their professional problems.

The method implemented according to the present disclosure provides an automated processing layer by providing users with a neuromorphic use case oriented solution in order to avoid complex operations experienced by users during a complete neuromorphic experiment process. The neuromorphic use case repository can help users to model independently instead of relying entirely on experts. The neuromorphic use case repository can have some common use cases built in and can be continuously enriched and updated. This solution also enables users to select the best solutions for their professional problems by comparing the performance of use cases across a plurality of neuromorphic software-hardware simulation platforms.

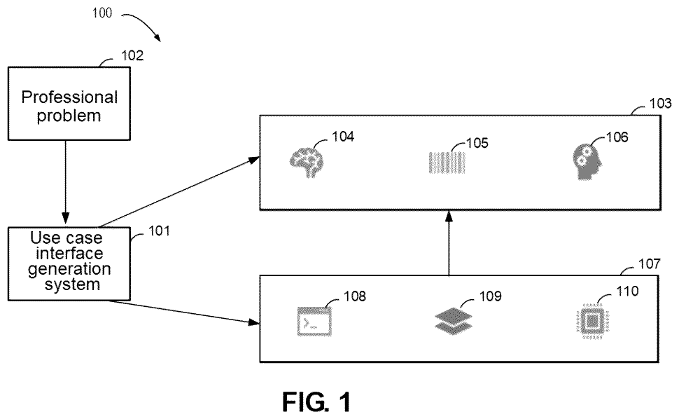

Fundamental principles and a plurality of example embodiments of the present disclosure will be described in detail below with reference to the accompanying drawings. Among them, FIG. 1 illustrates a schematic diagram showing a neuromorphic computation system 100 comprising a use case interface generation system 101. It should be understood that the number and the arrangement of elements or components such as devices, hardware, and software, as well as the process of data transmission, illustrated in FIG. 1 are only examples. Different numbers of devices, hardware, software, etc. that are arranged in different ways, as well as various additional elements, may be included in FIG. 1, which is not limited in the present disclosure in any way.

In the neuromorphic computation system 100, a professional problem 102 may be one or more problems that need to be solved using neuromorphic computation. As examples, the professional problem 102 may be one or more of a stereo visualization problem, gesture recognition, expression recognition, a visual flow problem, image classification and object tracking, a real-time spatio-temporal sensory information processing problem, a machine learning problem, a robotics problem, an online speech recognition problem, an audio feature extraction problem, a probabilistic inference problem, an energy efficient neuromorphic classification problem, text and image recognition, a recursive neural network problem, a cryptographic problem, a computational chemistry problem, a supply chain logistics problem, and control and navigation problems for robots and other smart mobile devices. It should be understood that the problems listed above are only examples and that the professional problem 102 may include any one or more problems that need to be solved using neuromorphic computation, and the like, which is not limited in the present disclosure in any way.

As shown in FIG. 1, when the use case interface generation system 101 encounters the professional problem 102 that requires neuromorphic computation, the use case interface generation system 101 first needs to model the professional problem 102 in a spiking neuromorphic network 103, sometimes referred to as an SNN. For example, the use case interface generation system 101 needs to select a neuromorphic model 104 associated with the professional problem 102, and needs to input a code 105 to the spiking neuromorphic network 103 and select a learning method 106 suitable for the neuromorphic model 104.

In another aspect, the use case interface generation system 101 also needs to set the relevant environment for a hardware layer 107 that supports the spiking neuromorphic network 103. For example, the use case interface generation system 101 needs to set a software simulator 108 associated with the spiking neuromorphic network 103, set a connection 109 between the hardware layer 107 and a software layer of the spiking neuromorphic network 103, and select hardware 110 adapted to the spiking neuromorphic network 103.

As an example, in this neuromorphic computation system 100, the hardware layer 107 may be any computing device having processing computing resources or storage resources. For example, the hardware layer 107 has common capabilities such as receiving and sending data requests, real-time data analysis, local data storage, real-time network connectivity, and the like. The computing devices may typically include various types of devices. Examples of the computing devices include, but are not limited to: desktop computers, laptop computers, smartphones, wearable devices, security devices, smart manufacturing devices, smart home devices, Internet of Things (IoT) devices, smart cars, drones, and the like. In the neuromorphic computation system 100, any number and any type of devices may be included, which is not limited in the present disclosure in any way.

Additionally or alternatively, the hardware layer 107 may also be any cloud computing device with storage capabilities, such as a general-purpose server, a dedicated server, a desktop server, a rack server, a cabinet server, a blade server, etc., which is not limited in the present disclosure in any way. The cloud computing device may further be deployed as a private cloud, a community cloud, and a hybrid cloud, among others, and the present disclosure is not limited in this regard. The cloud computing device may also have characteristics such as providing computing power based on user needs and being compatible with different software or hardware. Additionally or alternatively, any localized architecture may be used to implement the cloud computing device.

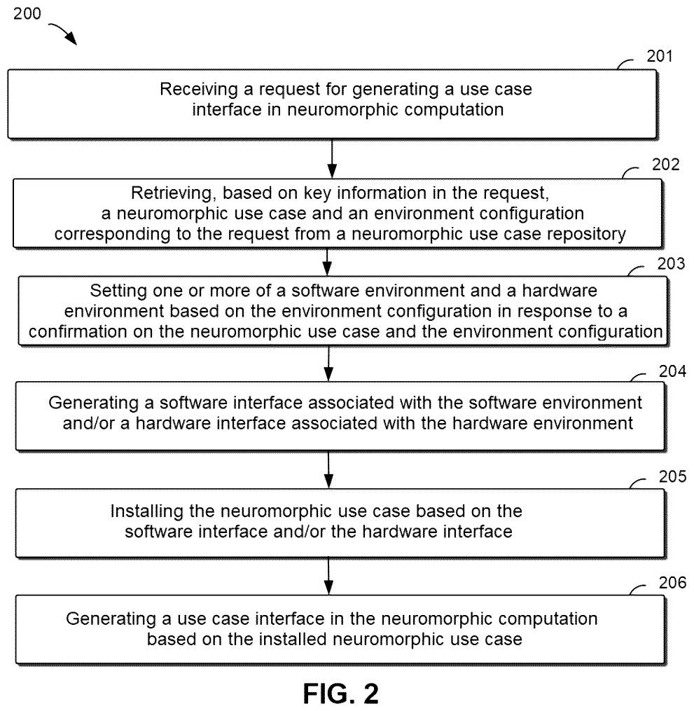

FIG. 2 illustrates a flow chart of a method 200 for generating a use case interface in neuromorphic computation according to embodiments of the present disclosure. The elements in FIG. 2 may be the same as or similar to the elements in FIG. 1.

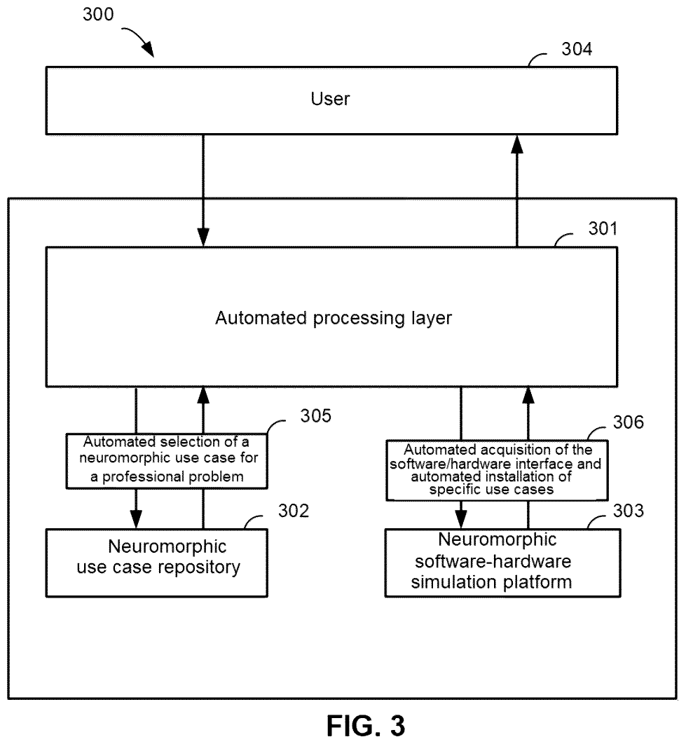

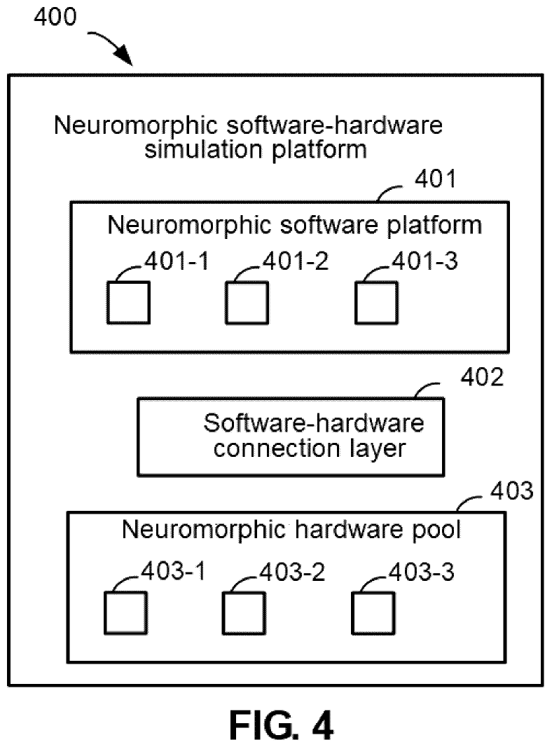

At block 201, a request for generating a use case interface in the neuromorphic computation is received. According to embodiments of the present disclosure, the use case interface generation system may first receive a request for a use case interface from a user. According to embodiments of the present disclosure, the use case interface generation system may include, but is not limited to, elements such as an automated processing layer, a neuromorphic use case repository, and a neuromorphic software-hardware simulation platform, and the use case interface generation system may be used to generate a user interface for the user request. The use case interface generation system will be described specifically below in conjunction with FIG. 3 and FIG. 4.

At block 202, a neuromorphic use case and an environment configuration corresponding to the request are retrieved from a neuromorphic use case repository based on key information in the request. According to embodiments of the present disclosure, the use case interface generation system may then perform a semantic analysis of the user request and extract the key information from the user request. Such key information may include keywords, metadata, and identifiers that match the usage scenario or use case of the user request, the solution corresponding to the professional problem 102 that the user requests to solve, and the like. It should be understood that the above description of the key information is only an example and the present disclosure does not limit the type of the key information in any way. In some embodiments, the use case interface generation system may also perform weighting calculation on one or more pieces of the extracted key information to measure their importance in the request.

The use case interface generation system can automatically search the neuromorphic use case repository for a neuromorphic use case and an environment configuration that correspond to the request and/or contain such key information. The use case interface generation system can also score the relevance of a plurality of neuromorphic use cases and environment configurations in the neuromorphic use case repository according to the word frequency, the field length norm, the vector distance, and other factors of the key information in neuromorphic use cases, and return to the user one or more associated neuromorphic use cases and environment configurations as retrieval results.

According to embodiments of the present disclosure, a neuromorphic use case may be a description of an application scenario that utilizes neuromorphic computation techniques to solve a particular professional problem 102 or implement a particular function. As an example, neuromorphic use cases may be solutions for controlling the perception, control, and navigation in robots and other smart mobile devices, solutions for face or gesture recognition, solutions for image or audio feature extraction, supply chain optimization solutions, and the like, which is not limited in the present disclosure in any way.

In some embodiments, the user or expert can also input existing neuromorphic use cases and environment configurations to the neuromorphic use case repository to build or supplement the neuromorphic use case repository. The neuromorphic use case repository may include neuromorphic use cases and environment configurations suitable for solving the various professional problems 102 described above. According to embodiments of the present disclosure, the environment configuration may be a software environment configuration and a hardware environment configuration associated with the neuromorphic use case. For example, when the neuromorphic use case is a solution for face or gesture recognition, the environment configuration may be information about the software environment configuration and hardware environment configuration applicable to solving face or gesture recognition problems.

At block 203, one or more of a software environment and a hardware environment are set based on the environment configuration in response to a confirmation on the neuromorphic use case and the environment configuration. According to embodiments of the present disclosure, the user selects a neuromorphic use case and an environment configuration suitable for the current request from the one or more associated neuromorphic use cases and environment configurations returned by the use case interface generation system. Upon receiving the confirmation on the neuromorphic use case and the environment configuration, the use case interface generation system can set one or more of the software environment and hardware environment based on the environment configuration, for example, selecting a neuromorphic model and a learning method suitable for the current neuromorphic use case, selecting a software simulator and hardware suitable for the current neuromorphic use case, and so on, which is not limited in the present disclosure in any way.

At block 204, a software interface associated with the software environment and/or a hardware interface associated with the hardware environment is generated. According to embodiments of the present disclosure, after the software environment and the hardware environment are set, the use case interface generation system can generate the corresponding software interface and/or hardware interface based on the software environment and the hardware environment. The software interface can be used to implement information interaction between neuromorphic software, which specifies the content and actions to be done by the neuromorphic computation software, while allowing the user to not spend time focusing on the details of the neuromorphic software function implementation, and also to easily replace or modify the implementation, thus improving inter-software scalability and flexibility. The hardware interface can be used to enable data transmission between neuromorphic hardware and between software and hardware.

At block 205, the neuromorphic use case is installed based on the software interface and/or the hardware interface. According to embodiments of the present disclosure, the use case interface generation system can install a neuromorphic use case selected by the user on the software interface and the hardware interface. In some embodiments, the use case interface generation system may install and interface the neuromorphic use case with the generated software interface and hardware interface so as to run the neuromorphic use case by invoking the software interface and hardware interface.

At block 206, a use case interface is generated in the neuromorphic computation based on the installed neuromorphic use case. The use case interface generation system may further generate a use case interface based on the installed neuromorphic use case and the associated software interface and hardware interface, so that the user can enable the neuromorphic use case by invoking the use case interface and via the software interface and hardware interface when the neuromorphic use case needs to be run, which reduces the burden of modeling the neuromorphic use case for the user.

The flow chart of the method for generating a use case interface in neuromorphic computation according to embodiments of the present disclosure is depicted above in conjunction with FIG. 2. The method implemented according to the present disclosure can prevent the user from going through complex operations during a complete neuromorphic experiment process, reduce complex operations of performing a neuromorphic experiment by the user, provide the user with an out-of-box neuromorphic solution, and reduce the difficulty for the user to model neuromorphic use cases independently.

A diagram of the overall architecture of a use case interface generation system 300 according to embodiments of the present disclosure is described below in conjunction with FIG. 3. The elements in FIG. 3 may be the same as or similar to the elements in FIG. 1. As shown in FIG. 3, the use case interface generation system 300 may include an automated processing layer 301, a neuromorphic use case repository 302, and a neuromorphic software-hardware simulation platform 303. The automated processing layer 301 may automate all operations during the neuromorphic experiment. The automated processing layer 301 may receive a request from a user 304 to generate a use case interface and may automatically search the neuromorphic use case repository for a neuromorphic use case needed for solving the relevant professional problem 102. The automated processing layer 301 may also combine the neuromorphic use case repository 302 and the neuromorphic software-hardware simulation platform 303 to provide the user 304 with an out-of-box use case interface and neuromorphic solution.

The neuromorphic use case repository 302 may store neuromorphic use cases that have been fully modeled as well as associated environment configurations, so as to assist the user in conducting neuromorphic experiments. Upon receiving a search request from the automated processing layer 301, the neuromorphic use case repository 302 may return recommendations of one or more associated neuromorphic use cases and environment configurations. The user 304 may further select, from these recommended one or more neuromorphic use cases and environment configurations, the use case that best matches his or her professional problem. In this way, instead of manually modeling his or her professional problem from the outset, the user 304 can directly use the recommended neuromorphic use cases and environment configurations or modify the recommended neuromorphic use cases and environment configurations to better fit the user 304's own needs. Automated selection of neuromorphic use cases for professional problems can be achieved through an interaction 305 between the automated search function of the automated processing layer 301 and the neuromorphic use case repository 302.

The neuromorphic software-hardware simulation platform 303 is responsible for handling the execution environment of the neuromorphic experiment. The neuromorphic software-hardware simulation platform 303 integrates a plurality of software simulators and hardware simulators to provide the user with a variety of execution environments. In combination with the automated setting function of the automated processing layer 301, the neuromorphic use cases are executed on various platforms, thus helping the user 304 to compare the differences between multiple neuromorphic use cases and multiple environment configurations after combination more easily and quickly, and finally choose the best solution. Automated acquisition of the software and/or hardware interfaces and automated installation of specific use cases can be achieved through an interaction 306 between the automated setting function of the automated processing layer 301 and the neuromorphic software-hardware simulation platform 303.

The diagram of the overall architecture of the use case interface generation system has been described above in conjunction with FIG. 3, and a diagram of the internal architecture of a neuromorphic software-hardware simulation platform 400 in a use case interface generation system will be described below in conjunction with FIG. 4. It should be understood that the number and arrangement of elements or components illustrated in FIG. 4 are only examples. The neuromorphic software-hardware simulation platform 400 may include different numbers of devices, hardware, software, etc. that are arranged in different ways, various additional elements, etc., which are not limited in the present disclosure in any way.

As shown in FIG. 4, the neuromorphic software-hardware simulation platform 400 may include components such as a neuromorphic software platform 401, a software-hardware connection layer 402, and a neuromorphic hardware pool 403. The neuromorphic software platform 401 can integrate a plurality of neuromorphic software simulators, for example, 401-1 to 401-3, and these neuromorphic software simulators 401-1 to 401-3 can utilize a spiking neural network to implement information processing and learning similar to biological neural systems and generate corresponding software interfaces. The neuromorphic software platform 401 also allows for rapid development and testing of neuromorphic computation applications and algorithms without relying on specific hardware platforms. Examples of the neuromorphic software simulators 401-1 to 401-3 may include, but are not limited to, the Brian simulator, the BindsNET simulator, the Norse simulator, the NEST simulator, the Nengo simulator, and the like. It should be understood that the neuromorphic software simulators listed above are only examples. The neuromorphic software platform 401 may include any type and any number of known or unknown neuromorphic software simulators, which is not limited in the present disclosure in any way. The neuromorphic software platform 401 may run neuromorphic use cases in dedicated computing resources and provide full support on hardware such as CPUs or GPUs.

The neuromorphic software-hardware simulation platform 400 may also include the neuromorphic hardware pool 403, wherein this neuromorphic hardware pool 403 integrates a plurality of pieces of accessible neuromorphic hardware 403-1 to 403-3, and such neuromorphic hardware 403-1 to 403-3 can use spiking neural networks as the underlying computational models, and can enable asynchronous, parallel, or distributed data processing, and generate corresponding hardware interfaces. The neuromorphic hardware enables efficient artificial intelligence applications such as perception, recognition, behavior, and thinking at very low power consumption. Examples of the neuromorphic hardware 403-1 to 403-3 may include, but are not limited to, Akida chips, BrainScaleS, SpiNNaker chips, TrueNorth chips, Loihi chips, Zeroth chips, and the like. It should be understood that the neuromorphic hardware listed above is only exemplary. The neuromorphic hardware pool 403 may include any type and any number of known or unknown neuromorphic hardware, which is not limited in the present disclosure in any way. The neuromorphic hardware pool 403 may provide the user with a neuromorphic hardware backend to run neuromorphic use cases on real neuromorphic hardware.

The neuromorphic software-hardware simulation platform 400 may also include a software-hardware connection layer 402, and the software-hardware connection layer 402 can implement backends for some neuromorphic software simulators to execute neuromorphic use cases on real neuromorphic hardware. If the user wishes to run the neuromorphic use case on the real neuromorphic hardware, this software-hardware connection layer 402 will establish connectivity between the neuromorphic software and the neuromorphic hardware, such as by connecting the software interface and the hardware interface to execute the neuromorphic use case on the neuromorphic hardware backend via the neuromorphic software simulator frontend. Thus, this neuromorphic software-hardware simulation platform 400 provides the user with multiple flexible neuromorphic software and hardware frontends and/or backends (“ends”) so that the user can compare the performance of a specified neuromorphic use case on different simulation backends and select the best solution.

As an example, in some embodiments, after selecting a neuromorphic use case to be run, the user may select one or more neuromorphic software simulators from a plurality of neuromorphic software simulators in the neuromorphic software platform 401 and select one or more pieces of neuromorphic hardware from a plurality of pieces of neuromorphic hardware in the neuromorphic hardware pool 403. The user may then combine the selected one or more neuromorphic software simulators with the selected one or more pieces of neuromorphic hardware to obtain one or more neuromorphic software-hardware simulation schemes. The user may also invoke the use case interface associated with the one or more neuromorphic software-hardware simulation schemes, thereby running the selected neuromorphic use cases in the one or more neuromorphic software-hardware simulation schemes.

Additionally or alternatively, in some embodiments, the user may also compare the neuromorphic software-hardware simulation scheme performance scores obtained by running the same neuromorphic use case in different neuromorphic software-hardware simulation schemes. Depending on different neuromorphic use cases, the measurement criteria for the neuromorphic software-hardware simulation scheme performance scores may be different. For example, in the neuromorphic use case of image recognition, the measurement criteria for the neuromorphic software-hardware simulation scheme performance scores may be the accuracy of image recognition. As another example, in the neuromorphic use case of control and navigation of a mobile device, the measurement criteria for the neuromorphic software-hardware simulation scheme performance scores may be the navigation accuracy or the shortest distance of the path. It should be understood that the above listed measurement criteria for the neuromorphic software-hardware simulation scheme performance scores are examples only. The measurement criteria for the neuromorphic software-hardware simulation scheme performance scores may vary depending on different neuromorphic use cases, which is not limited in the present disclosure in any way.

By comparing the neuromorphic software-hardware simulation scheme performance scores obtained by running the same neuromorphic use case in different neuromorphic software-hardware simulation schemes, the user can select, for example, the neuromorphic software-hardware simulation scheme with the highest score as the final neuromorphic software-hardware simulation scheme that best fits the selected neuromorphic use case.

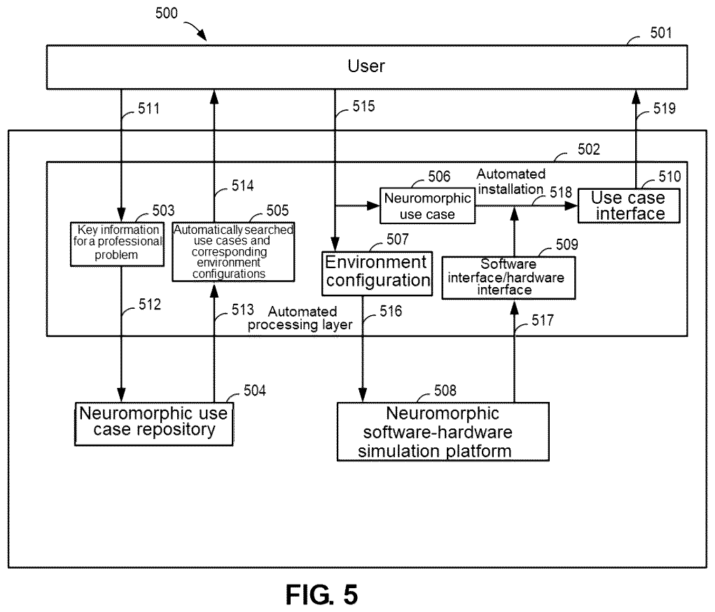

A schematic diagram for a user to generate a use case interface using a use case interface generation system 500 according to embodiments of the present disclosure will be described below in conjunction with FIG. 5. As shown in FIG. 5, when a user 501 attempts to acquire a neuromorphic solution by a method according to the present disclosure, the user 501 may first send 511 to an automated processing layer 502 a request directed to a specific professional problem. Once the request is received by the automated processing layer 502, the request can be analyzed and key information 503 for a professional problem can be extracted from it.

Subsequently, the automated processing layer 502 may automatically search 512 a neuromorphic use case repository 504 for one or more neuromorphic use cases and environment configurations corresponding to the request based on the key information and return 513 the recommended, automatically searched neuromorphic use cases and corresponding environment configurations 505 to the automated processing layer 502. The automatically searched neuromorphic use cases and corresponding environment configurations 505 may then be returned 514 to the user 501 as a recommendation via the automated processing layer 502.

The user 501 may then perform selection from the returned one or more neuromorphic use cases and environment configurations and confirm 515 therefrom a neuromorphic use case 506 and an environment configuration 507 that are suitable for the professional problem. The confirmation 515 may be sent back to the automated processing layer 502 by the user 501. After the automated processing layer 502 receives the confirmation 515 on the neuromorphic use case 506 and the environment configuration 507 from the user, the automated processing layer 502 may send the environment configuration 507 to a neuromorphic software-hardware simulation platform 508 to automatically set 516 the software and/or hardware environment in the neuromorphic software-hardware simulation platform 508.

The neuromorphic software-hardware simulation platform 508 can then set one or more of the software environment and the hardware environment based on the environment configuration and, after the one or more of the software environment and the hardware environment (software simulator and/or hardware simulator) have been set, generate a software interface associated with the software environment (software simulator) and/or a hardware interface 509 associated with the hardware environment (hardware simulator), and then the neuromorphic software-hardware simulation platform 508 can send 517 the software interface and/or hardware interface 509 back to the automated processing layer 502.

By utilizing the software interface and/or hardware interface 509, the automated processing layer 502 can automatically install 518 the neuromorphic use case 506 selected by the user on the software interface and/or hardware interface 509 and further generate a ready-to-use use case interface 510. The automated processing layer 502 may then return 519 the ready-to-use use case interface 510 to the user 501.

When the user 501 needs to run a neuromorphic use case associated with a professional problem, the user 501 just needs to invoke the ready-to-use use case interface 510. This saves the user 501 the time cost and learning cost of manually building the neuromorphic use case and its associated environment configuration, thus greatly reducing the complexity of the entire process.

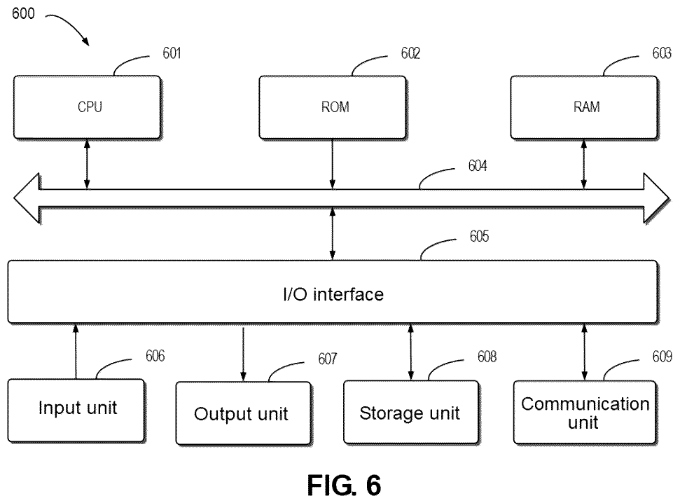

FIG. 6 illustrates a block diagram of an example device 600 that may be used to implement embodiments of the present disclosure. The computing device in FIG. 1 may be implemented using the device 600. As shown in the figure, the device 600 includes a central processing unit (CPU) 601 that may execute various appropriate actions and processing according to computer program instructions stored in a read-only memory (ROM) 602 or computer program instructions loaded from a storage unit 608 to a random access memory (RAM) 603. In the RAM 603, various programs and data required for the operation of the device 600 may also be stored. The CPU 601, the ROM 602, and the RAM 603 are connected to each other through a bus 604. An input/output (I/O) interface 605 is also connected to the bus 604.

A plurality of components in the device 600 are connected to the I/O interface 605, including: an input unit 606, such as a keyboard and a mouse; an output unit 607, such as various types of displays and speakers; a storage unit 608, such as a magnetic disk and an optical disc; and a communication unit 609, such as a network card, a modem, and a wireless communication transceiver. The communication unit 609 allows the device 600 to exchange information/data with other devices via a computer network, such as the Internet, and/or various telecommunication networks.

The various processes and processing procedures described above, such as the method 200, may be performed by the CPU 601. For example, in some embodiments, the method 200 may be implemented as a computer software program that is tangibly included in a machine-readable medium, such as the storage unit 608. In some embodiments, part of or all the computer program may be loaded and/or installed onto the device 600 via the ROM 602 and/or the communication unit 609. One or more actions of the method 200 described above may be performed when the computer program is loaded into the RAM 603 and executed by the CPU 601.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, wherein the programming languages include object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the embodiments disclosed herein.

What is claimed is:

1. A method for generating a use case interface in neuromorphic computation, comprising:
receiving a request for generating a use case interface in the neuromorphic computation;
retrieving, based on key information in the request, a neuromorphic use case and an environment configuration corresponding to the request from a neuromorphic use case repository;
setting one or more of a software environment and a hardware environment based on the environment configuration in response to a confirmation on the neuromorphic use case and the environment configuration;
generating a software interface associated with the software environment and/or a hardware interface associated with the hardware environment;
installing the neuromorphic use case based on the software interface and/or the hardware interface; and
generating a use case interface in the neuromorphic computation based on the installed neuromorphic use case.

2. The method according to claim 1, wherein one or more of the software environment and the hardware environment is set by a neuromorphic software-hardware simulation platform based on the environment configuration, and the neuromorphic software-hardware simulation platform comprises a neuromorphic software platform, a neuromorphic software-hardware connection layer, and a neuromorphic hardware pool.

3. The method according to claim 2, wherein the neuromorphic software platform comprises a plurality of neuromorphic software simulators for executing the neuromorphic use case in dedicated computing resources.

4. The method according to claim 2, wherein the neuromorphic hardware pool comprises a plurality of pieces of neuromorphic hardware for executing the neuromorphic use case in the neuromorphic hardware.

5. The method according to claim 2, wherein the neuromorphic software-hardware connection layer establishes a connection between the neuromorphic software platform and the neuromorphic hardware pool for executing the neuromorphic use case in the neuromorphic hardware pool via the neuromorphic software platform.

6. The method according to claim 2, further comprising:
combining one or more of a plurality of neuromorphic software simulators of the neuromorphic software platform with one or more of a plurality of pieces of neuromorphic hardware of the neuromorphic hardware pool to obtain one or more neuromorphic software-hardware simulation schemes;
running the neuromorphic use case in the one or more neuromorphic software-hardware simulation schemes to obtain neuromorphic software-hardware simulation scheme performance scores for the neuromorphic use case; and
obtaining, by comparing the respective neuromorphic software-hardware simulation scheme performance scores for the same neuromorphic use case, a neuromorphic software-hardware simulation scheme suitable for the neuromorphic use case.

7. The method according to claim 1, comprising:
building the neuromorphic use case repository by inputting existing neuromorphic use cases and environment configurations to the neuromorphic use case repository.

8. The method according to claim 1, wherein said confirmation on the neuromorphic use case and the environment configuration further comprises:
selecting the neuromorphic use case and the environment configuration from a plurality of neuromorphic use cases and a plurality of environment configurations.

9. The method according to claim 1, further comprising:
providing a service for the neuromorphic computation by running the use case interface.

10. An electronic device, comprising:
at least one processor; and
a memory coupled to the at least one processor and having instructions stored therein, wherein the instructions, when executed by the at least one processor, cause the electronic device to perform actions comprising:
receiving a request for generating a use case interface in neuromorphic computation;
retrieving, based on key information in the request, a neuromorphic use case and an environment configuration corresponding to the request from a neuromorphic use case repository;
setting one or more of a software environment and a hardware environment based on the environment configuration in response to a confirmation on the neuromorphic use case and the environment configuration;
generating a software interface associated with the software environment and/or a hardware interface associated with the hardware environment;
installing the neuromorphic use case based on the software interface and/or the hardware interface; and
generating a use case interface in the neuromorphic computation based on the installed neuromorphic use case.

11. The electronic device according to claim 10, wherein one or more of the software environment and the hardware environment is set by a neuromorphic software-hardware simulation platform based on the environment configuration, and the neuromorphic software-hardware simulation platform comprises a neuromorphic software platform, a neuromorphic software-hardware connection layer, and a neuromorphic hardware pool.

12. The electronic device according to claim 11, wherein the neuromorphic software platform comprises a plurality of neuromorphic software simulators for executing the neuromorphic use case in dedicated computing resources.

13. The electronic device according to claim 11, wherein the neuromorphic hardware pool comprises a plurality of pieces of neuromorphic hardware for executing the neuromorphic use case in the neuromorphic hardware.

14. The electronic device according to claim 11, wherein the neuromorphic software-hardware connection layer establishes a connection between the neuromorphic software platform and the neuromorphic hardware pool for executing the neuromorphic use case in the neuromorphic hardware pool via the neuromorphic software platform.

15. The electronic device according to claim 11, the actions further comprising:
combining one or more of a plurality of neuromorphic software simulators of the neuromorphic software platform with one or more of a plurality of pieces of neuromorphic hardware of the neuromorphic hardware pool to obtain one or more neuromorphic software-hardware simulation schemes;
running the neuromorphic use case in the one or more neuromorphic software-hardware simulation schemes to obtain neuromorphic software-hardware simulation scheme performance scores for the neuromorphic use case; and
obtaining, by comparing the respective neuromorphic software-hardware simulation scheme performance scores for the same neuromorphic use case, a neuromorphic software-hardware simulation scheme suitable for the neuromorphic use case.

16. The electronic device according to claim 10, the actions comprising:
building the neuromorphic use case repository by inputting existing neuromorphic use cases and environment configurations to the neuromorphic use case repository.

17. The electronic device according to claim 10, wherein said confirmation on the neuromorphic use case and the environment configuration further comprises:
selecting the neuromorphic use case and the environment configuration from a plurality of neuromorphic use cases and a plurality of environment configurations.

18. The electronic device according to claim 10, the actions further comprising:
providing a service for the neuromorphic computation by running the use case interface.

19. A computer program product, the computer program product being tangibly stored on a non-transitory computer-readable medium and comprising machine-executable instructions, wherein the machine-executable instructions, when executed by a machine, cause the machine to perform steps of:
receiving a request for generating a use case interface in neuromorphic computation;
retrieving, based on key information in the request, a neuromorphic use case and an environment configuration corresponding to the request from a neuromorphic use case repository;
setting one or more of a software environment and a hardware environment based on the environment configuration in response to a confirmation on the neuromorphic use case and the environment configuration;
generating a software interface associated with the software environment and/or a hardware interface associated with the hardware environment;
installing the neuromorphic use case based on the software interface and/or the hardware interface; and
generating a use case interface in the neuromorphic computation based on the installed neuromorphic use case.

20. The computer program product according to claim 19, wherein one or more of the software environment and the hardware environment is set by a neuromorphic software-hardware simulation platform based on the environment configuration, and the neuromorphic software-hardware simulation platform comprises a neuromorphic software platform, a neuromorphic software-hardware connection layer, and a neuromorphic hardware pool.
